(19) United States
(12) Patent Application Publication
(10) Pub. No.: US 2006/0293024 A1
(43) Pub. Date: Dec. 28, 2006

(54) Methods and apparatus for improved 911 support for VoIP service

(75) Inventors: David S. Benco, Winfield, IL (US); Sanjeev Mahajan, Naperville, IL (US); Baoling S. Sheen, Naperville, IL (US); Sandra Lynn True, St. Charles, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/159,697

(22) Filed: Jun. 23, 2005

(51) Int. Cl. H04M 11/04

(52) U.S. Cl. 455/404.2; 455/404.1

(57) ABSTRACT

Systems and methods are presented for routing 911 or other emergency calls from VoIP terminal equipment, wherein the terminal includes GPS or other means to obtain geographic location information for the current location when a 911 call is initiated, and the terminal includes the geographic location information in a call setup request message to the service provider. Routing logic receives the set request and uses the geographic information to search one or more databases to identify the proper emergency service center to which the call is routed, and also the street address corresponding to the caller's current location. The emergency call is then routed to the selected service center, where the call may be delivered with the street address or the street address information is updated in an ALI database of the 911 system by the routing logic before or during call delivery to ensure the emergency service operator or dispatcher knows where to direct emergency services.

### FIELD OF THE INVENTION

The present invention relates to telecommunications in general, and more particularly to improved systems and methods for 911 support for voice-over-IP service.

### BACKGROUND OF THE INVENTION

Traditional telephone systems provide voice communications between called parties, and have been adapted to provide information transfer using modems that transmit and receive data signals along telephone lines. Conventional telephone systems provide interconnection of telephones or modems of a calling party and a called party using switching networks and systems to provide dedicated voice connection during a particular call, sometimes referred to as plain-old-telephone service (POTS). The analog signals at each end of a call connection are typically digitized at a central office (CO) switch, and pulse code modulated (PCM) to represent each analog signal sample as a code word, which is then transported using time division multiplexing (TDM) through the POTS system to a destination central office which converts the received code words to analog form for transmission over a local loop to the other party. For a given call, an end-to-end path is set-up through the public switched telephone network (PSTN) prior to the initiation of the actual voice conversation, where the connection path remains the same throughout the call.

More recently, telecommunications customers have been provided with a vast array of different types of communications services. In particular, wireless phones and the Internet have become commonplace in modem society. Wireless communications systems and networks have been constructed and interconnected with the wire-line telephone network to allow mobile devices to communicate with other mobile devices as well as with ordinary stationary telephones. The wireless systems include various infrastructure to service a wide geographic area divided into regions or “cells” with base stations serving one or more such cells and networked mobile switching centers (MSCs) serving one or more base stations, where the MSCs are operatively coupled with one another and other systems by a wireless network and one or more MSCs may be coupled to a wire-based network to provide communications among and between wireless and/or wireline devices. In common cellular communications systems, the communication path is established through various MSCs and intervening networks and the data is sent in digital form over the same path throughout the call session. Wireless fidelity (WiFi) systems have also become popular, in which the telephone communications data is transferred in packets, wherein the transfer path may change during a call, whereby different packets may travel along different routes, with the received packets being reassembled at the recipient device for conversion to analog audio for provision to the subscriber or user. The Internet has also been developed and has proliferated in recent years to become a popular communications medium in which data is transferred in packets between devices connected to the network.

In addition to allowing transfer of other information, the internet and other packet-switched networks are now being employed as a medium for telephone traffic, in which voice information is provided in a data stream with other data streams being used for data transfer, a technology referred to as voice-over-IP (VoIP), wherein IP refers to the Internet protocol for the data link layer. VoIP telephones and other VoIP terminals can be operatively connected to the internet by cables using Ethernet cards or other network interfaces, as well as through IP multimedia subsystem (IMS) Wifi networks, and once connected, can provide telephone service regardless of the point of connection with the network. In this regard, such VoIP terminals are essentially mobile devices that retain the same phone number at any location, whereby users can originate and receive calls and also interface to other services provided over the Internet.

Emergency services have been available for some time through conventional telephone systems, wherein a caller dials “911 ” to connect with emergency service providers in the immediate area. In conventional wire-line systems, each telephone is connected to a telephone line in a known location, whereby the providers of 911 (or “enhanced 911 ” (E911 )) emergency services can ascertain the telephone number of a calling party and consult an automatic location identifier (ALI) database to translate the telephone number to street address and subscriber name information. In this regard, when a 911 emergency dispatch person receives a call, it may be essential to direct service providers (e.g., fire department, ambulance, police, etc.) to the correct street address quickly to aid the caller, particularly where the caller is unable to vocally provide the address information to the dispatcher. Thus, for conventional fixed-location telephones, the ALI database provides valuable information in the context of 911 calls. However, since VoIP telephones or terminals can be moved, the ALI database may not reflect the current caller location when a VoIP user places an emergency call to the 911 service. As a result, there is a need for improved methods and apparatus for providing 911 support for VoIP services.

### SUMMARY OF THE INVENTION

A summary of one or more aspects of the invention is now presented to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The invention relates to systems and methodologies to aid in ensuring that emergency services are delivered to the current location of VoIP phones and other VoIP terminals when a 911 or other type of emergency call is placed. The invention provides for provision of location information by the VoIP terminal in a call setup request message, such as a SIP invite request or other setup request message. The VoIP terminal is preferably equipped with GPS circuitry or other suitable means by which the terminal can automatically ascertain the current location information, such as longitude and latitude coordinates. The service provider receives the location information and uses this to determine a corresponding street address and to select a suitable emergency service center to which the 911 call is then routed. The call can be delivered to the 911 center with the street address information, or the VoIP service provider routing logic can update the street address for the caller's phone number in an automatic location identifier (ALI) database associated with the emergency service center before or during the call delivery. In this manner, the invention ensures that the emergency system dispatcher or operator will know the current street address to direct appropriate services to the caller, particularly where the VoIP terminal has moved since it's location was last reported to the VoIP service provider and where the caller either does not know their current street address or is unable to provide the address vocally during the call.

One aspect of the invention provides methods for delivering or routing emergency calls from VoIP terminal users, including automatically obtaining geographic location information from a VoIP terminal originating an emergency call. In one example, the geographic location information is automatically obtained using a global positioning system (GPS) module of the VoIP terminal, and the terminal sends a call setup request message that includes the geographic location information. The method further includes selecting an emergency service center corresponding to the geographic location information, for example, by searching a first database having a geographic location to emergency service center mapping to find an emergency service center corresponding to the geographic location information. In one implementation, routing logic of the VoIP service provider receives the geographic location information and searches the first database to select the appropriate service center. A street address may also be identified according to the geographic location information, such as by performing a search of a second database having a geographic location to street address mapping. The routing logic may then update the ALI database used by the 911 service center to include the identified street address, or may deliver the street address to the emergency center along with the call signaling, whereby the 911 service provider has the necessary information readily available to dispatch emergency services in an expedited fashion without having to obtain the address from the caller. In one example, the call signaling may also include the caller's phone number.

Another aspect of the invention provides a method for emergency call origination in a voice-over-IP (VoIP) terminal. The method comprises automatically obtaining geographic location information corresponding to a current location of a VoIP terminal (e.g., automatically using a global positioning system (GPS) module of the VoIP terminal), and constructing a call request setup message including the geo location information. The call request setup message is then sent to a VoIP service provider. In one example, the geographic location information is obtained when a user initiates an emergency call, or alternatively, the VoIP terminal may periodically acquire and store the GPS longitude and latitude values, with the most recently acquired location being used in the emergency call request setup message.

Yet another aspect of the invention relates to an emergency call routing system including means for automatically obtaining geographic location information indicating a current location of a VoIP terminal originating an emergency call. In one implementation, a global positioning system (GPS) module of the VoIP terminal is used to obtain the longitude and latitude coordinates for the terminal, which then relays the information to the VoIP service provider in the call setup request message. The system also includes means for selecting an emergency service center corresponding to the geographic location information, such as a database having a geographic location to emergency service center mapping and an emergency call routing logic system that receives the geographic location information in the call setup request message. In this example, the logic system searches the database to find an emergency service center corresponding to the geographic location information and routes the emergency call to the selected emergency service center. Means are also provided for identifying a street address corresponding to the geographic location information, such as a second database with a geographic location to street address mapping. The routing logic system searches the database using the geographic location information to find the corresponding street address, and either updates the ALI database with the identified street address or includes the street address with the call delivered to the selected emergency service center. The logic may also update geographic location information in the ALI database, and the ALI database may be modified to implement a new class of service for VoIP phones.

Another aspect of the present invention provides a VoIP terminal, comprising a GPS module or other means for automatically obtaining geographic location information corresponding to a current location of the VoIP terminal, and means for constructing a call request setup message including the geo location information. The terminal also includes means for sending the call request setup message to a VoIP service provider, so that the provider can ascertain street address or other useful information in routing the emergency call to the appropriate emergency service center based on the location information in the call setup request message. In one implementation, the geographic location information is obtained by the terminal when a user initiates an emergency call. Other implementations are possible, in which the VoIP terminal acquires and saves the geographic location information periodically, with the most recently acquired location being included in the emergency call request setup message.

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings, in which:

FIG. 1 is a system diagram illustrating a GPS enabled voice-over-IP (VoIP) terminal originating an emergency 911 call, and a system for delivering or routing the emergency call to a 911 service provider in accordance with one or more aspects of the present invention;

FIG. 2 is a system diagram illustrating further details of the exemplary VoIP terminal including a GPS module and IP network interface components for creating and forwarding a 911 call setup request message including geographic location information corresponding to a current location of a VoIP terminal;

FIG. 3 illustrates an exemplary SIP invite request emergency call setup request message having a Geo-Location tag with longitude and latitude values in accordance with the invention;

FIG. 4 is a simplified schematic view illustrating an exemplary ALI database that is accessible by an emergency 911 service center of FIG. 1, including VoIP records with street address information and optional geographic location information to support a new class of service for VoIP phones;

FIG. 5 is a flow diagram illustrating an exemplary method of emergency call origination in a VoIP terminal according to the present invention;

FIG. 6A is a flow diagram illustrating an exemplary method for routing an emergency call from a VoIP terminal in which an ALI database is updated with the current street address before or during call delivery in accordance with the invention;

FIG. 6B is a flow diagram illustrating another exemplary VoIP emergency call routing method of the invention, wherein the street address information is provided to the emergency service center with the delivered call; and

FIG. 7 is a flow diagram illustrating an exemplary method of emergency call servicing at a 911 emergency center, in which the street address of the caller is ascertained from an ALI database or alternatively is received with the 911 call.

### DETAILED DESCRIPTION OF THE INVENTION

The invention relates to systems and methods for improved emergency 911 support in VOIP service. One or more exemplary implementations of the present invention are hereinafter illustrated and described, wherein like reference numerals are used to refer to like elements throughout and wherein the invention is not limited to the illustrated examples. Although illustrated and described below in the context of certain exemplary networks and systems, the invention finds utility in association with any type of communications apparatus and systems in which VoIP devices are operable to place emergency calls.

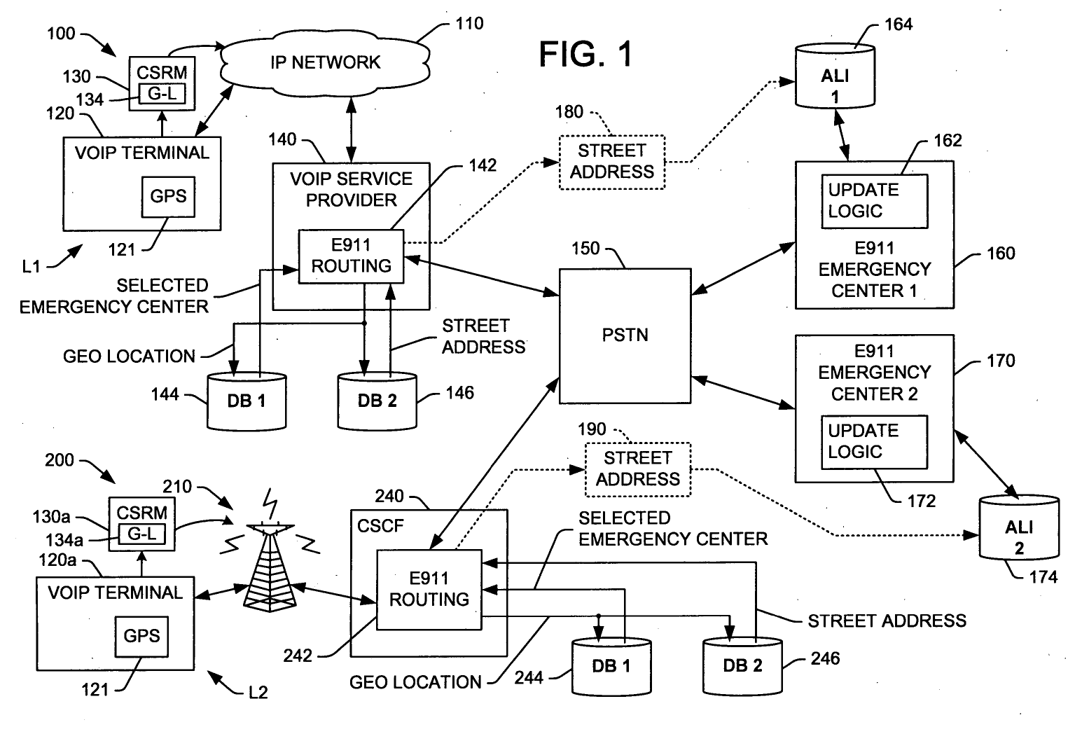

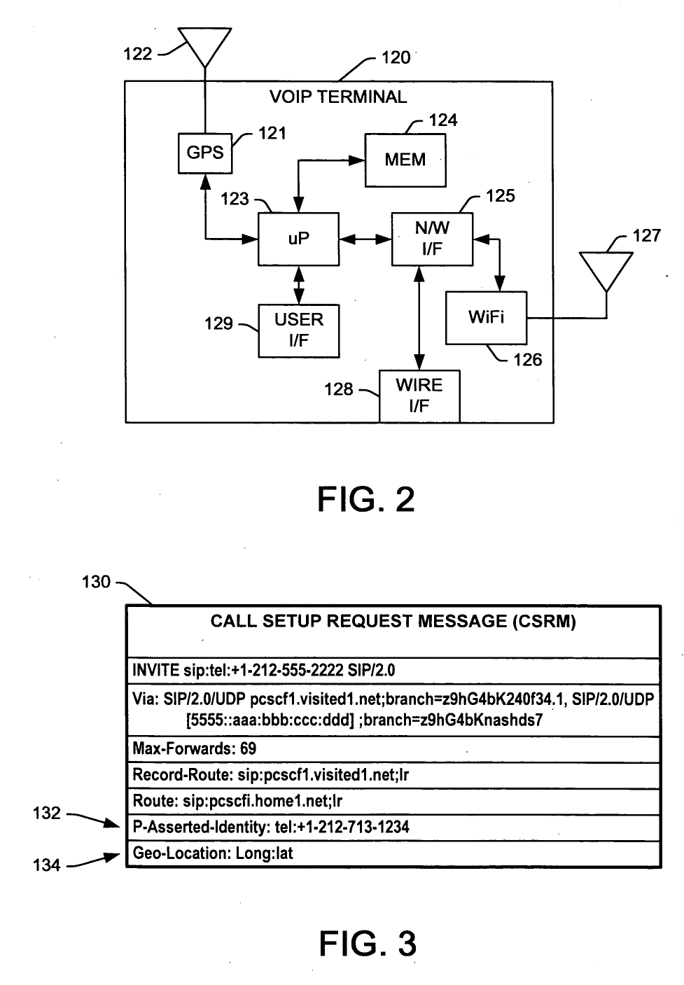

Referring initially to FIGS. 1-4, FIG. 1 shows an IP-based communication system 100, including an IP network 110 operatively coupled with a voice-over-IP (VoIP) service provider 140, and a GPS enabled VoIP terminal 120 operatively connected to the IP network 110. The terminal 120 can be any VoIP device which provides telephone services via an IP-based network such as network 110, and may be connected to the network 110 by any suitable means, such as direct wiring or through a wireless IP based interface (IMS-WiFi). In accordance with an aspect of the invention, the VoIP terminal 120 includes a GPS module or circuit 121 by which the terminal 120 can obtain and store geographic position location information in automated fashion without user action, wherein FIG. 2 illustrates further details of the exemplary VoIP terminal 120 as described further below. The VoIP service provider 140 can be a server, data store, software in a server, or other hardware and/or software configured or otherwise adapted to perform the functionality set forth herein, wherein the various network elements and data stores illustrated and described may be integrated or separate components and the various entities may be distributed across many network elements or systems. The service provider 140 is operatively connected to a public switch telephone network (PSTN) 150, wherein telephone service is rendered to the terminal 120 by the service provider 140 for originating and/or receiving calls to or from telephones via the PSTN 150 (conventional wire-line telephones and/or wireless phones), and/or with other VoIP phones through the IP network 110.

As shown in FIG. 1, VoIP terminal 120 is situated at a first location L1 when connected to the IP network 110, for example where the terminal 120 is situated in an office building at the location L1 and is connected to the IP network 110 through a cable (not shown). FIG. 1 further illustrates another possible operational connection of the VoIP terminal to the PSTN 150, wherein the VoIP terminal is at a second location L2 within a wireless IP-based communications network 200 (the exemplary VoIP terminal is numerically designated in FIG. 1 as “120a” at this second location L2). In this example, the wireless network 200 is an IMS WiFi network having one or more transmitter/receiver based stations 210 providing communications interface between the VoIP terminal 120a and a call session control function (CSCF) 240, wherein the CSCF 240 is also operatively connected to the PSTN 150. As shown in FIG.1, the VoIP terminal 120 can therefore provide IP-based telephone service to a user at different locations, via the IP network 110 and the VoIP service provider 140, or alternatively through the CSCF240 depending on the current location of the VoIP terminal 120 (L1 or L2 respectively).

As further as illustrated in FIG. 1, the PSTN 150 provides telephone connection to various emergency 911 service centers, wherein two such service centers 160 and 170 are illustrated in FIG. 1. In this example, a first emergency service center 160 is the closest such center to the first location L1 of the VoIP terminal 120, and the first emergency center 160 is operatively connected to a first automatic location identifier (ALI) database 164. The ALI database 164 allows translation of a caller's telephone number (e.g., caller ID) to street address and/or subscriber name information during an emergency 911 call, wherein the ALI database 164 is updated by providers of plain old telephone services (POTS services) when a hard wired telephone is moved or a line is added, and is also updated by wireless service providers dynamically as subscribers thereof move from place to place. In operation when a 911 call is received at the emergency center 160 from the conventional or wireless telephone (not shown) through the PSTN 150, the emergency center 160 performs a search of the database 164 to find the corresponding street address (and possibly the subscriber's name) so that emergency services can be provided at (dispatched to) the location from which an emergency call originated. The second exemplary emergency service center 170 is similarly operatively connected to a second ALI database 174 and to the PSTN 150, wherein the second emergency center 170 is an appropriate center to provide emergency services for 911 calls originating in the second location L2. The emergency service centers 160 and 170, moreover, include update logic or systems 162 and 172, respectively, allowing operators or dispatchers to update the respective ALI databases 164 and 174, for example, where a caller indicates a different street address during an emergency call than that which is indicated in the database.

In accordance with the present invention, the IP-based telephone service providers 140, 240 include emergency call (911) routing logic or systems 142 and 242, respectively, to route or deliver 911 calls from VoIP terminals such as terminal 120, 120a to the appropriate emergency service center 160, 170. It is noted at this point that absent the provisions at the present invention, merely providing the phone number corresponding to the VoIP terminal 120 to an emergency center 160 or 170 may be insufficient to allow emergency operators or dispatchers to ascertain the current location and street address information for VoIP terminal 120 using conventional ALI database searches. Furthermore, since the VoIP terminal 120, 120a maintains the same phone number at both the locations L1 and L2, the phone number by itself is not necessarily indicative of the appropriate emergency service center 160, 170 to which a 911 call should be delivered or routed, since the phone number itself is not restricted to any particular location. The invention accordingly provides a system for routing emergency calls from the VoIP terminal such as terminal 120, 120a, including apparatus for automatically obtaining geographic location (G-L) information 134 that indicates a current location of a VoIP terminal 120, 120a that is originating an emergency call. Toward these ends, the system of the invention includes routing logic 142, 242 associated with the VoIP service provider, wherein the routing logic systems 142, 242 can be any suitable network element, whether hardware, software, or combinations thereof, and can be located in any suitable network element or may be distributed across two or more such elements, wherein all such alternative implementations are contemplated as falling within the scope of the invention and the appended claims.

In addition to the routing logic 142, 242 associated with an IP-based telephone service provider, the systems of the invention further provide one or more data stores or databases 144, 146, which can be separate from or integrated with the logic 142 or other network element. The routing logic 142, 242 receives the G-L information 134, 134a from the originating VoIP terminal 120, 120a and uses this in a database search to identify the appropriate emergency center 160, 162 to which a 911 call should be routed, and also determine a street address corresponding to the current VoIP terminal location (e.g. L1 or L2 in this example). The routing logic 142 then makes the identified street address available to operators and/or dispatchers at the selected emergency center 160, 170. In this fashion, the emergency center operator can quickly direct appropriate emergency services to the caller regardless of the current location of the terminal 120, 120a, and regardless of whether the caller knows or is able to communicate the correct street address information to the operator.

In the case of FIG. 1 where the VoIP terminal 120 is located at the first location L1, upon a caller initiating a 911 emergency call from the terminal 120, the GPS module 121 is activated and obtains the geographic coordinates (e.g., longitude and latitude) for the current location L1. The originating terminal 120 then constructs a call set up request message 130 (CSRM 130 as shown in greater detail in FIG. 3 below), where the CSRM 130 includes the geographic location (longitude and latitude) information 134. At the first location in L1 with the VoIP terminal 120 communicating with the IP network 110, the set up request message 130 can be any suitable message by which an originating emergency call can be initiated by a VoIP terminal device 120, in this example a session initiation protocol (SIP) INVITE request message 130 as shown in FIG. 3. In the example of FIG. 3, the call set up request message 130 includes a P-asserted-identity tag 132 including the phone of the VoIP terminal 120, as well as geo location tag 134 in which the longitude and latitude or other suitable geographic location information is provided. From the location L1, the terminal 120 provides this CSRM 130 to the VoIP service provider 140 through the IP network 110. Alternatively, when the terminal 120a is located at position L2, the CSRM 130a and the G-L information 134a thereof are provided to the serving CSCF 240 via the base station 210 in the wireless network 200.

When such an emergency call setup request message 130 is received in the VoIP service provider 140, the provider 140 initially determines whether or not the requested call is an emergency (e.g., 911) call. If not, the call is delivered using normal procedures. However, for 911 or other emergency calls, the routing logic system 142 of the VoIP provider 140 obtains the geographic location information 134 from the call setup request message 130. The emergency call routing logic system 142, moreover, is operatively connected or coupled with first and second databases 144 and 146, respectively, wherein the routing logic 142 performs searches in the databases 144 and 146 using the automatically obtained geographic location information 134. The databases 144 and 146 may be separately maintained or may be integrated, and may be located anywhere within the VoIP service provider 140 or elsewhere within the IP base network 100 and may be interconnected with the logic system 142 in any suitable fashion that allows access by the system 142 to the data therein.

In the illustrated emergency call routing system, the first database 144 has a geographic location to emergency service center mapping, which may be any suitable data structure by which one or more appropriate emergency service centers (160, 170, etc.) may be identified to provide or direct emergency services to a particular geographic location. The second database 146, moreover, provides a geographic location to street address mapping, which can be any suitable data structure or storage organization by which the closest appropriate street address is identified for any given geographic location. In this example, upon receiving the geographic location information 134 from the CSRM 130, the 911 routing logic system 142 performs a database search of the first database 144 to find an emergency service center corresponding to the geographic location information 134 for location L1, in this case, the first emergency service center 160. This is the service center to which the requested emergency call will be routed or delivered from the VoIP terminal 120.

In addition, the 911 routing logic system 142 performs a search of the second database 146 to find a street address 180 corresponding to the geographic location information (corresponding to the current location L1). In one implementation of the invention, the routing logic system 142 is also operatively coupled with the first ALI database 164 that serves the first emergency center 160. In this case, prior to or during delivery of the requested 911 call to the selected emergency center 160, the logic 142 updates the ALI 164 with the identified street address 180 obtained from the search of the second database 146. In this implementation moreover, the logic system 142 routes the call through appropriate messaging and signaling through the PSTN 150 to the selected emergency center 160, including the phone number (e.g., caller ID) corresponding to the calling VoIP terminal 120. In this manner, when the operator or dispatcher of the selected emergency service center 160 receives the 911 call from the VoIP terminal 120, the ALI database 164 can be searched using the phone number provided with the call, whereby the operator or dispatcher will be able to identify the appropriate street address 180 corresponding to the current VoIP terminal location L1.

In another possible implementation, the 911 routing logic system 142 performs the above described searches of the first and second databases 144 and 146 to obtain or identify the appropriate emergency center (160) and street address (180) for the call originating from location L1. In this case however, the routing logic system 142 delivers the 911 call to the selected emergency center 160 through the PSTN 150, with the caller phone number and the identified street address 180 being delivered with the call, through any suitable signaling or messaging associated with delivery of the emergency call. In this instance, the emergency center 160 may manually or automatically employ update means 162 to update the ALI database 164 with the current street address 180. This second approach, moreover, may be easily implemented where the emergency center 160 is directly accessible via VoIP or other IP-based service network components, with the ability to easily transfer the street address 180 in text form along with the call packets.

In both of the above scenarios, upon receipt of the 911 call at the selected emergency service center 160, a determination is made at the center 160 as to whether the caller street address 180 was received with the call. If not, the ALI database 164 is searched using the caller's phone number to obtain the corresponding street address 180 for the caller location L1. At that point, the emergency services can be dispatched using the obtained street address 180 as well as any information provided vocally by the caller. In the case where the street address was provided with the call, the emergency call service can proceed without necessarily having to consult the ALI database 164.

As shown in FIG. 1, the VoIP terminal 120a may alternatively be located at location L2. The aspects of the invention operate in similar fashion when the terminal 120a is at this alternate location L2, wherein the GPS-enabled VoIP terminal 120a uses the GPS module 121 thereof to obtain the geographic location information 134a corresponding to this new location L2 and constructs a SIP INVITE type call setup request message 130a including the G-L information 134a. This CSRM 130a is directed through the base station 210 of the IMS system 200 to the serving CSCF 240. The CSCF 240 provides similar IP-based telephone services to visiting VoIP devices such as terminal 120a within the IP-based wireless system 200.

With respect to emergency call services, the CSCF 240 includes emergency 911 routing logic system 242 having similar or equivalent functionality to the system 142 described above with respect to the service provider 140. The routing logic system 242 is operatively associated with first and second databases 242 and 246, respectively, wherein the first database 244 includes a mapping of geographic location to one or more suitable emergency service centers and the second database 246 provides a geographic location to street address mapping. As with the above described example in the IP network 100, the emergency center mapping in the first database 242 of the wireless system 200 may be one to one or one to many, in which one or more suitable emergency service centers (e.g. 160, 170, etc.) may be identified for a given geographic location. The mapping of the second database 246, however, is typically one to one, with a single street address being provided or indicated for each unique geographic location (e.g. a single street address 190 will be identified for the second location L2).

Upon receipt of the CSRM 130a and the G-L information 134a thereof, the routing logic system 242 performs a search of the first database 244 to find an emergency service center (service center 170 in this example) that corresponds to the geographic location L2 of the VoIP terminal 120a. A search of the second database 246 is also conducted using the provided G-L information 134a, to yield the street address 190 corresponding to the second location L2. With the search results, the routing logic 242 directs, routes, or otherwise delivers the 911 call from the terminal 120a to the selected emergency center 170 together with the caller's phone number through the PSTN 150. The street address information 190 is also provided to facilitate provisional emergency services to the location L2 by operators and/or dispatchers of the emergency center 170. In one implementation, the routing logic 242 is operatively connected to the second ALI database 174 associated with the emergency center 170, wherein the logic 242 updates the ALI 174 to include the street address 190 corresponding to the phone number of the calling VoIP terminal 120a. This update of the ALI 174 may be before or during delivery of the 911 call to the selected emergency center 170. In another implementation, the street address information 190 is provided to the selected emergency center 170 with the actual emergency 911 call.

FIG. 2 illustrates further details of the exemplary GPS-enabled VoIP terminal phone 120, including a GPS module or system 121 that is operatively coupled with an antenna 122 for communications and data exchange between the GPS module 121 and several GPS satellites (not shown), by which the GPS module 121 can at any time obtain the geographic location information 134 (latitude, longitude, altitude, etc.) corresponding to the present location of the VoIP terminal 120. The terminal 120 further includes a microprocessor 123 connected to the GPS module 121 as well as a memory (RAM, ROM, etc.) 124, a user interface 129 (e.g. including keypad, buttons, display, microphone, speaker, etc.) allowing a user (not shown) to interface with the VoIP terminal 120 for telecommunications and other services, and a network interface 125, which provides operational connection of the VoIP terminal 120 with an IP-based network (e.g., IP network 100, IMS/WiFi network 200, etc.) through a wire line interface 128 or a WiFi (wireless) interface 126 connected to a second antenna 127.

Referring also to FIG. 3, as discussed above, VoIP terminal 120 is operable to obtain the current geographic location information 134 via the GPS system 121, and to create a call set up request message CSRM 130 having or including the geographic location information 134. One example of a suitable CSRM 130 is illustrated in FIG. 3, in which the message 130 is a SIP INVITE request message having various tags or fields as illustrated. In accordance with the invention, the message 130 includes a Geo-Location tag or field 134 in which longitude and latitude information is provided, as well as an optional field or tag 132 which includes the telephone number of the calling VoIP terminal 120.

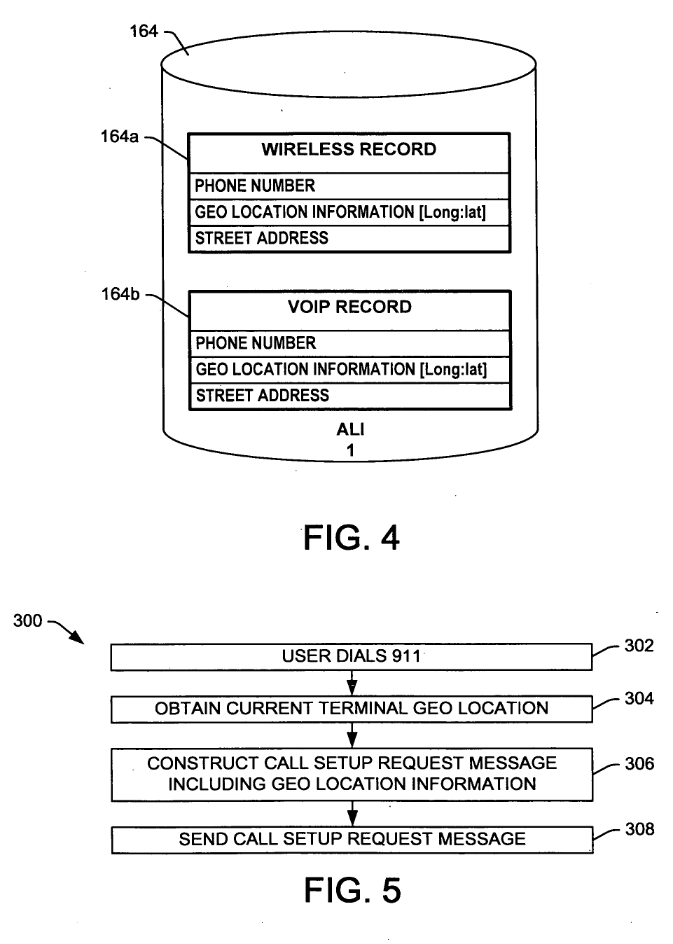

FIG. 4 illustrates the exemplary first ALI database 164 operatively associated with the first emergency service center 160 of FIG. 1, wherein the ALI database 164 includes various records, or is operable to store the information of such records in any suitable associative manner allowing searching of the record information according to phone number. As shown in FIG. 4, wireless records 164a are maintained or are otherwise accessible to allow wireless phone numbers to be searched to yield geographic location information (e.g. longitude and latitude), as updated by wireless service providers. In addition, searching the wireless record 164a by phone number will yield street address information which is then used by emergency operators or dispatchers.

In accordance with the present invention, moreover, the ALI database 164 provides a new class of service (e.g. VoIP). For IP-based telecommunications terminals (e.g. terminal 120). As schematically illustrated in FIG. 4, corresponding VoIP records 164b are stored in the database 164 including phone number, geographic location information, and street address, whereby an emergency service center 160 searching the database 164 by phone number can ascertain geographic location information and/or street address information from the records 164b for VoIP terminals such as terminal 120, as well as obtaining street address information for numbers associated with non VoIP devices. Furthermore, the new VoIP class of service for the ALI database 164 allows the VoIP service provider 140, 240 and the 911 routing logic systems 142, 242 thereof to updated VoIP records 164b with new street address information 180, 190 and/or new geographic location information 134, 134a at any time, for example, whenever the VoIP terminal device 120 is moved, or upon a user initiating an emergency call using the terminal 120.

Referring now to FIG. 5, a method 300 is illustrated for originating an emergency call and a VoIP terminal. Although the method 300 and other methods of the invention are illustrated and described hereinafter as a series of acts or events, it will be appreciated that the various methods of the invention are not limited by the illustrated ordering of such acts or events. In this regard, some acts or events may occur in different order and/or concurrently with other acts or events apart from those illustrated and described herein in accordance with the invention. It is further noted that not all illustrated steps may be required to implement a process or method in accordance with the present invention. The methods of the invention, moreover, may be implemented in association with the illustrated communication systems, messages, and user equipment or terminals, as well as other apparatus not illustrated or described, wherein all such alternatives are contemplated as falling within the scope of the present invention and the appended claims. For example, the illustrated method 300 of FIG. may be implemented in the exemplary VoIP terminal 120, 120a illustrated and described above in association with FIGS. 1 and 2 for originating for emergency 911 calls using the exemplary call setup request message 130 of FIG. 3.

The method 300 begins at 302, where the user dials 911 on the VoIP terminal 120 or otherwise attempts to initiate an emergency call. In the case where the VoIP terminal 120 is located at L1 (FIG. 1 above), the VoIP terminal 120 may be adapted to periodically obtain and store the current geographic location information 134 (e.g. in memory 124 of FIG. 2 above), or may automatically obtain the current geographic location information at 304 upon the user initiating an emergency call. Thereafter at 306, the VoIP terminal 120 constructs a call request setup message (CRSM 130 of FIG. 3), which includes the geographic location information 134. CSRM message 134 is then sent at 308, whereby terminal 120 completes origination of the emergency call.

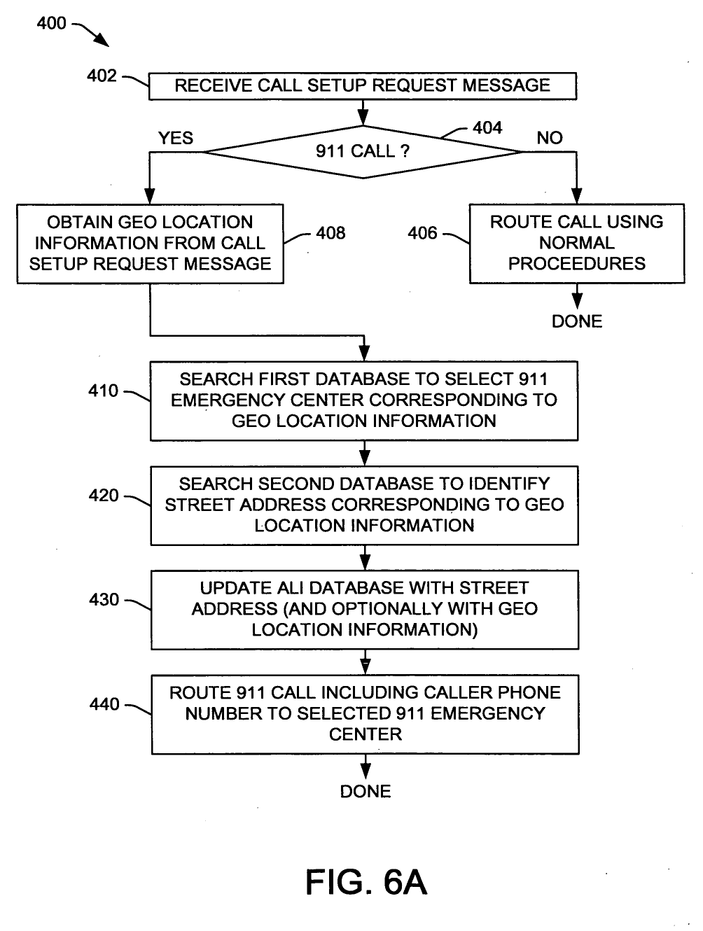

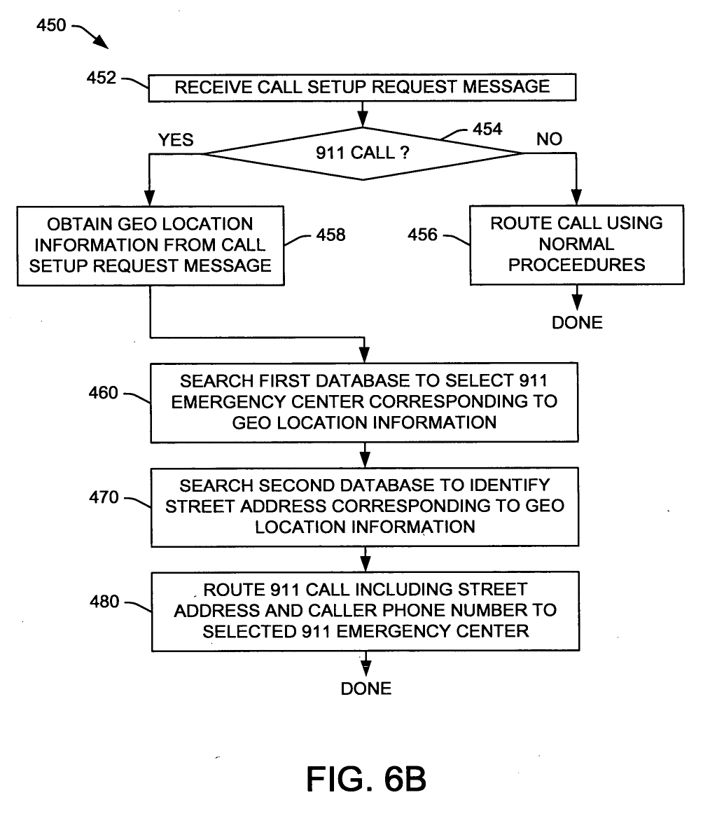

In accordance with another aspect of the invention a method 400 is illustrated in FIG. 6A for facilitating delivery or routing of emergency calls from VoIP terminals and the users thereof. The method 400 begins at 402 with receipt of CSRM (CSRM 130 above). In the situation of FIG. 1 where the VoIP service provider 140 receives the call from VoIP terminal 120 at location L1, the service provider 140 makes a determination at 404 in FIG. 6A as to whether the requested call is an emergency call or not (e.g. a 911 call). If not (NO at 404), the call is delivered or routed at 406 using normal procedures for the receiving IP-based network and the service provider 140 thereof. However, if the call setup request pertains to an emergency (911) call (YES at 404), the provider 140 obtains the geographic location information 134 from the call setup request message 130 at 408 in the method 400. Thereafter at 410, the 911 routing logic system 142 searches the first database (database 144 and FIG. 1) to select the appropriate 911 emergency service center (160) corresponding to the geographic location information. At 420, a second database (database 146) is searched using the geographic location information 134 to identify the corresponding street address (180). At 430, the routing logic 142 updates the corresponding ALI database (164) with the street address(180), and may optionally update the ALI database 164 with the geographic location information 134 received from the CSRM 130. The call is then delivered at 440 to the selected emergency service center (160), wherein the call includes the caller phone number.

Referring now to FIG. 6B, as discussed above, the emergency call may alternatively be delivered to the serving emergency center 160 along with the identified street address information (180), whereby the ALI database 164 need not be updated by the service provider routing logic 142 (and may then be updated manually or automatically using the emergency center update logic 172 of FIG. 1). FIG. 6B provides a method for 450 for routing emergency calls from VoIP users in accordance with this implementation of the invention. Beginning at 452, a call setup request message is received at 452, and a determination is made at 454 as to whether the request relates to an emergency call. If not (NO at 454), the method 450 proceeds to 456 where the call is delivered using normal VoIP procedures. For a 911 emergency call (YES at 454), the geographic location information is received or otherwise automatically obtained from the call setup request message at 458 and a first database is searched at 460 in order to select the appropriate 911 emergency service center corresponding to the geographic location information. A second database is then searched at 470 to identify the street address corresponding to the geographic location information, and the call is delivered at 480 to the selected 911 emergency center including the street address and caller phone number.

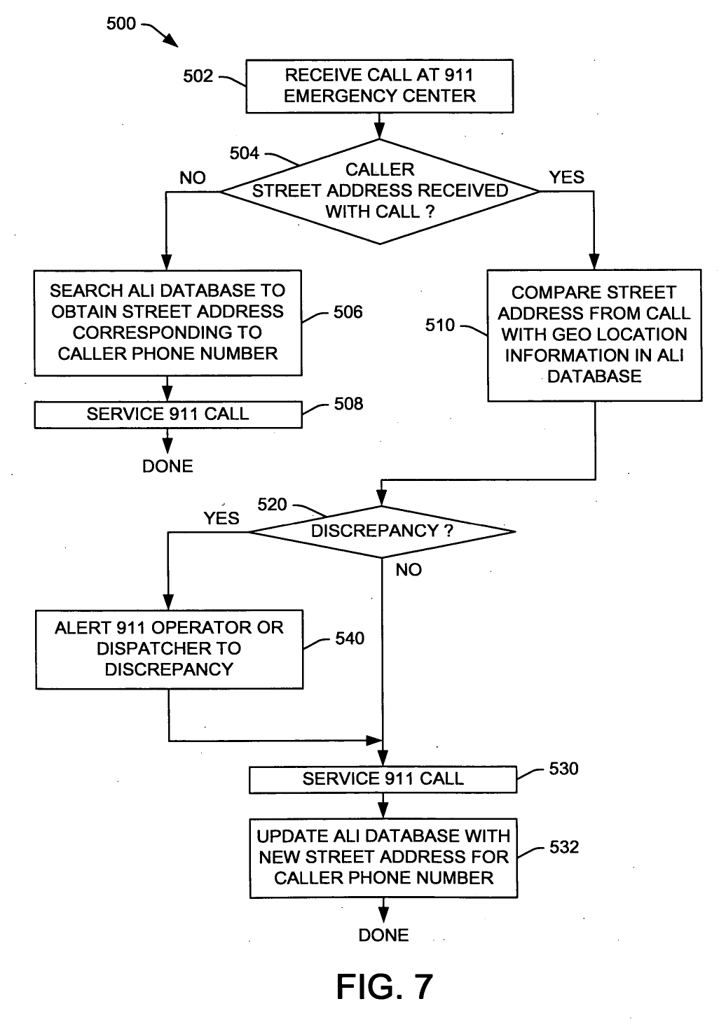

Referring now to FIG. 7, a method 500 is illustrated for servicing a 911 call received at the selected emergency service centers (e.g., centers 160, 170, etc.). The method 500 begins at 502 where a call is received at the emergency center (emergency center 160 in one example). A determination is made at 504 as to whether the caller street address (180) has been received with the call. If not (NO at 504), an ALI database (ALI 164) is searched at 506 to obtain the street address 180 corresponding to the caller phone number and the call is serviced at 508. In the case where a caller street address was received with the call (YES at 504), the method 500 proceeds to 510 where the street address 180 from the call is compared with the geographic location information in the ALI database 164 and a determination is made at 520 as to whether a discrepancy exists. If not (NO at 520) the call is serviced at 530 and the ALI database is updated at 532 with the new street address information for the caller phone number. If a discrepancy exists between the street address from the call and the geographic location information in the ALI database (YES at 520) the operator or dispatcher of the selected emergency service center 160 is alerted at 540 that a discrepancy exits, and the call is serviced at 530.

While the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A method for facilitating delivery of emergency calls from users of voice-over-IP (VoIP) terminals, the method comprising:
automatically obtaining geographic location information from a VoIP terminal originating an emergency call;
selecting an emergency service center corresponding to the geographic location information;
identifying a street address corresponding to the geographic location information;
updating an automatic location identifier (ALI) database accessible by the selected emergency service center with the identified street address; and
routing the emergency call to the selected emergency service center.

2. The method of claim 1, wherein automatically obtaining the geographic location information comprises receiving a call setup request message including the geographic location information from the VoIP terminal.

3. The method of claim 1, wherein the geographic location information is automatically obtained using a global positioning system (GPS) module of the VoIP terminal.

4. The method of claim 1, wherein selecting the emergency service center comprises performing a search of a first database having a geographic location to emergency service center mapping to find an emergency service center corresponding to the geographic location information.

5. The method of claim 4, wherein identifying the street address comprises performing a search of a second database having a geographic location to street address mapping to find a street address corresponding to the geographic location information.

6. The method of claim 4, wherein identifying the street address comprises performing a search of a database having a geographic location to street address mapping to find a street address corresponding to the geographic location information.

7. The method of claim 1, further comprising updating the ALI database with the automatically obtained geographic location information for the VoIP terminal originating the emergency call.

8. The method of claim 1, wherein the emergency call is routed to the selected emergency service center with a phone number of the VoIP terminal.

9. A method for facilitating delivery of emergency calls from users of voice-over-IP (VoIP) terminals, the method comprising:
automatically obtaining geographic location information for a VoIP terminal originating an emergency call;
selecting an emergency service center corresponding to the geographic location information;
identifying a street address corresponding to the geographic location information; and
routing the emergency call with the identified street address to the selected emergency service center.

10. A method of originating an emergency call in a voice-over-IP (VoIP) terminal, the method comprising:
automatically obtaining geographic location information corresponding to a current location of a VoIP terminal;
constructing a call request setup message including the geo location information; and
sending the call request setup message to a service provider.

11. The method of claim 10, wherein the geographic location information is automatically obtained using a global positioning system (GPS) module of the VoIP terminal.

12. The method of claim 10, wherein the geographic location information is obtained when a user initiates an emergency call.

13. A system for routing emergency calls from voice-over-IP (VoIP) terminals, comprising:
means for automatically obtaining geographic location information indicating a current location of a VoIP terminal originating an emergency call;
means for selecting an emergency service center corresponding to the geographic location information;
means for identifying a street address corresponding to the geographic location information;
means for updating an automatic location identifier (ALI) database accessible by the selected emergency service center with the identified street address; and
means for routing the emergency call to the selected emergency service center.

14. The system of claim 13, wherein means for automatically obtaining the geographic location information comprises a global positioning system (GPS) module of the VoIP terminal.

15. The system of claim 13, wherein the means for selecting an emergency service center comprises:
a database having a geographic location to emergency service center mapping; and
an emergency call routing logic system operatively coupled with the database and operatively coupled with an IP-base network to receive a call setup request message including the geographic location information from a VoIP terminal originating an emergency call, the logic system being operative to search the database to find an emergency service center corresponding to the geographic location information and to route the emergency call to the selected emergency service center.

16. The system of claim 13, wherein the means for identifying the street address comprises:
a database having a geographic location to street address mapping; and
an emergency call routing logic system operatively coupled with the database and operatively coupled with an IP-base network to receive a call setup request message including the geographic location information from a VoIP terminal originating an emergency call, the logic system being operative to search the database to find a street address corresponding to the geographic location information and to update the ALI database with the identified street address.

17. A system for routing emergency calls from voice-over-IP (VoIP) terminals, comprising:
means for automatically obtaining geographic location information indicating a current location of a VoIP terminal originating an emergency call;
means for selecting an emergency service center corresponding to the geographic location information;
means for identifying a street address corresponding to the geographic location information; and
means for routing the emergency call with the identified street address to the selected emergency service center.

18. The system of claim 17, wherein means for automatically obtaining the geographic location information comprises a global positioning system (GPS) module of the VoIP terminal.

19. The system of claim 17, wherein the means for selecting an emergency service center comprises:
a database having a geographic location to emergency service center mapping; and
an emergency call routing logic system operatively coupled with the first database and operatively coupled with an IP-base network to receive a call setup request message including the geographic location information from a VoIP terminal originating an emergency call, the logic system being operative to search the first database to find an emergency service center corresponding to the geographic location information and to route the emergency call to the selected emergency service center.

20. The system of claim 17, wherein the means for identifying the street address comprises:
a database having a geographic location to street address mapping; and
an emergency call routing logic system operatively coupled with the database and operatively coupled with an IP-base network to receive a call setup request message including the geographic location information from a VoIP terminal originating an emergency call, the logic system being operative to search the database to find a street address corresponding to the geographic location information and to update the ALI database with the identified street address.

21. A voice-over-IP (VoIP) terminal, comprising:
means for automatically obtaining geographic location information corresponding to a current location of the VoIP terminal;
means for constructing a call request setup message including the geo location information; and
means for sending the call request setup message to a service provider.

22. The VoIP terminal of claim 21, wherein the means for automatically obtaining the geographic location information comprises a global positioning system (GPS) module of the VoIP terminal.

23. The VoIP terminal of claim 21, wherein the geographic location information is obtained when a user initiates an emergency call.
